(19) United States
(12) Patent Application Publication
(10) Pub. No.: US 2014/0375579 A1
(43) Pub. Date: Dec. 25, 2014

(54) INPUT DEVICE, INPUT METHOD, AND STORAGE MEDIUM

(71) Applicant: CASIO COMPUTER CO., LTD., Tokyo (JP)

(72) Inventor: Hiroyuki Fujiwara, Tokyo (JP)

(21) Appl. No.: 14/305,363

(22) Filed: Jun. 16, 2014

(30) Foreign Application Priority Data
Jun. 21, 2013 (JP) 2013-130628

(51) Int. Cl. G06F 3/041

(52) U.S. Cl. CPC G06F 3/041
USPC 345/173

(57) ABSTRACT

An input device includes: a display unit having a display area; a first sensor unit that is provided to be layered on the display area and detects first touch operation; at least one second sensor unit that is provided at an area that does not overlap the display area and detects second touch operation; and a control unit that acquires each detection result from the first sensor unit and the at least one second sensor unit and executes control processing corresponding to the detection result acquired.

This application is based on and claims the benefit of priority from Japanese Patent Application No. 2013-130628, filed on 21 Jun. 2013, the content of which is incorporated herein by reference.

### BACKGROUND OF THE INVENTION

1. Field of the Invention

The present invention relates to an input device, an input method, and a storage medium.

2. Related Art

A wrist watch type communication terminal device has existed in which a mobile phone having a liquid crystal touch screen is used by a user wearing around an arm by a belt (Japanese Unexamined Patent Application, Publication No. 2004-288172). Japanese Unexamined Patent Application, Publication No. 2004-288172 also discloses that a desired function corresponding to a cursor is realized by pressing the cursor (touching the cursor) displayed on a touch screen of the communication terminal device, for example, by a finger.

If such an electronic device for which a small size as mentioned above is desired is used by a user constantly carrying or wearing on a body, the size of the display or the size of the device including the display is preferably a size no larger than approximately several centimeters in height and width such as that of a credit card. On the other hand, in the case of being a smaller size, it is considered that a size of approximately 3 to 4 centimeters in height and width is realistic for a body of a wrist type watch, for example, from a perspective of usability, visibility, or the like of the device.

Since such an electronic device of smaller size has a smaller area that allows a user to perform an input operation, even if the user wants to perform a desirable input operation such as scrolling or rotating a screen arranged on a display by a fingertip, there has been a problem in that it is difficult to perform a desired input operation. For this reason, a user interface has been demanded that allows a user to readily perform a desired input operation without degrading the operability of a smaller electronic device.

### SUMMARY OF THE INVENTION

The present invention addresses the abovementioned problems and it is an object of the present invention to provide an input device, an input method, and a storage medium that allows a user to readily perform a desired input operation without degrading an input operation.

According to an embodiment of the present invention, an input device includes: a display unit having a display area; a first sensor unit that is provided to be layered on the display area and detects first touch operation; at least one second sensor unit that is provided at an area that does not overlap the display area and detects second touch operation; and a control unit that acquires each detection result from the first sensor unit and the at least one second sensor unit and executes control processing corresponding to the detection result acquired.

According to an embodiment of the present invention, an input method executed by an input device includes: a display unit having a display area; a first sensor unit that is provided to be layered on the display area and detects first touch operation; and at least one second sensor unit that is provided at an area that does not overlap the display area and detects second touch operation; the input method comprising the steps of: acquiring each detection result from the first sensor unit and the at least one second sensor unit; and executing control processing corresponding to the detection result acquired.

According to an embodiment of the present invention, a non-transitory storage medium encoded with a computer-readable program enables a computer that controls an input device including: a display unit having a display area; a first sensor unit that is provided to be layered on the display area and detects first touch operation; and at least one second sensor unit that is provided at an area that does not overlap the display area and detects second touch operation, to execute functions as: a control unit that acquires each detection result from the first sensor unit and the at least one second sensor unit and executes control processing corresponding to the detection result acquired.

### BRIEF DESCRIPTION OF THE DRAWINGS

FIGS. 1A and 1B provides schematic configuration diagrams showing an embodiment of an input device according to the present invention;

FIG. 2 is a block diagram showing a configuration example of an input device according to the embodiment;

FIG. 3A-3C provides schematic diagrams showing configuration examples of a touch sensor applied to an input device according to the embodiment;

FIG. 4 is a schematic diagram showing an example of an input method applied to an input device according to an embodiment;

FIG. 5 is a schematic diagram showing another configuration example of an input device according to an embodiment;

FIG. 6 is a schematic diagram showing another configuration example of an input device according to an embodiment;

FIG. 7 is a schematic diagram showing another configuration example of an input device according to an embodiment;

FIG. 8 is a schematic diagram showing another example of an input method applied to an input device according to an embodiment;

FIG. 9 is a schematic diagram showing another example of an input method applied to an input device according to an embodiment;

FIG. 10 is a schematic diagram showing another example of an input method applied to an input device according to an embodiment; and

FIGS. 11A and 11B provides schematic configuration diagrams showing an example of an electronic device to which an input device according to the present invention is applied.

### DETAILED DESCRIPTION OF THE INVENTION

In the following, an input device, an input method, and a storage medium according to the present invention are explained in detail by presenting embodiments.

### Input Device

Initially, an input device according to the present invention is described.

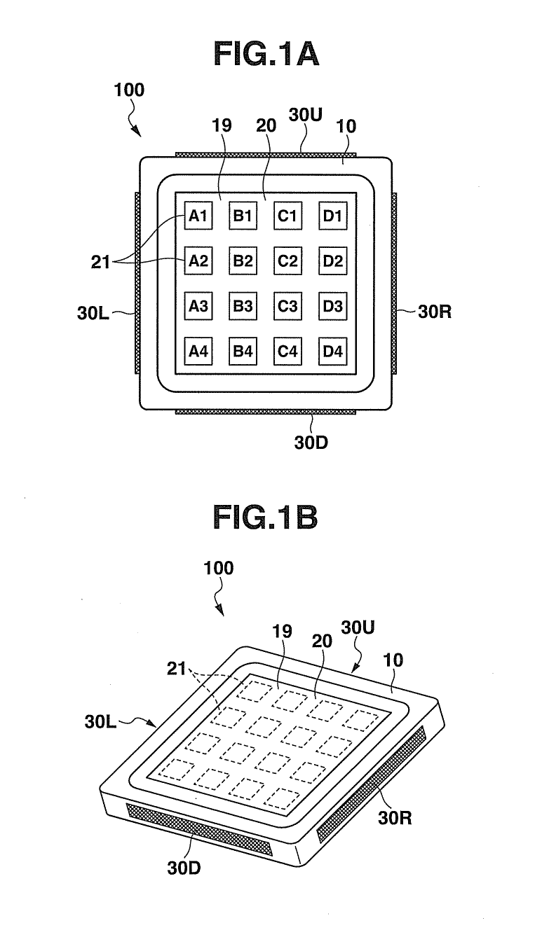

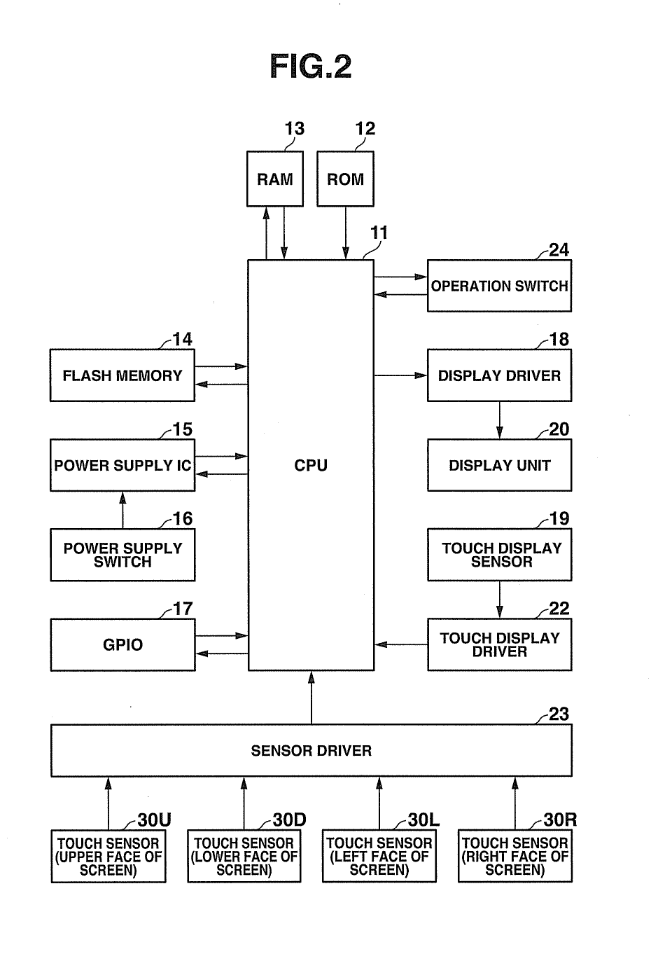

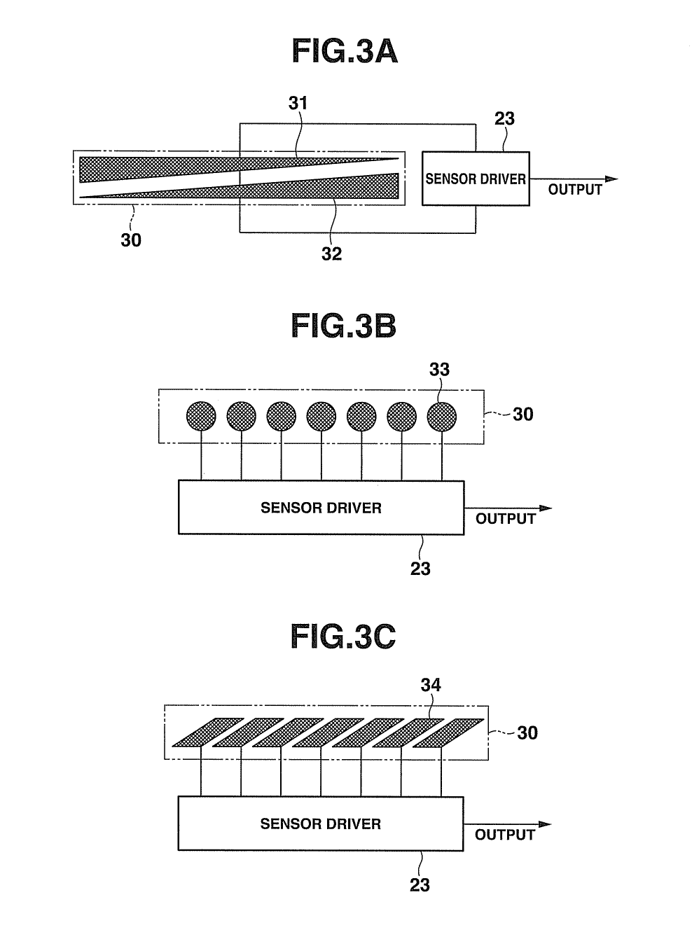

FIG. 1 is a schematic configuration diagram showing an embodiment of an input device according to the present invention. FIG. 2 is a block diagram showing a configuration example of an input device according to the present embodiment. FIG. 3 is a schematic diagram showing a configuration example of a touch sensor applied to an input device according to the present embodiment.

As shown in FIGS. 1A and 1B, for example, an input device 100 according to the present embodiment generally includes a display unit 20 having a display area in a rectangular shape, a housing 10 in a rectangular shape provided so as to at least surround an outer circumference of the display unit 20; and a first pair of touch sensors (a 21st sensor unit, a 22nd sensor unit) 30U, 30D and a second pair of touch sensors (a 23rd sensor unit, a 24th sensor unit) 30L, 30R provided to extend to lateral sides of an outer circumference of the housing 10.

Here, as seen from a user visually recognizing an icon 21 or the like displayed on the display area of the display unit 20, it is defined respectively that the right side of the display area is a right direction, the left side thereof is a left direction, an upper side thereof is an up direction, and a lower side thereof is a down direction.

The first pair of touch sensors 30U, 30D is arranged at a lateral side of the upper side of the display area and at a lateral side of the lower side of the display area, respectively. Then, the touch sensors 30U, 30D face each other interposing the display area of the display unit 20 and extend in a right-left direction (a first direction or a second direction) with respect to the display area of the display unit 20, respectively.

The second pair of touch sensors 30L, 30R is arranged at a lateral side of the left side of the display area and at a lateral side of the right side of the display area, respectively. Then, the touch sensors 30L, 30R face each other interposing the display area of the display unit 20 and extend in a vertical direction (a third direction or a fourth direction) that is perpendicular to the right-left direction with respect to the display area of the display unit 20, respectively.

More specifically, as shown in FIG. 2, for example, the input device 100 includes a CPU (input control unit) 11, ROM (Read Only Memory) 12, RAM (Random Access Memory) 13, Flash memory 14, an electric power supply IC 15, an electric power supply switch 16, a GPIO (General Purpose Input/Output) 17, a display driver 18, a touch display sensor 19 (a first sensor unit), a display unit 20, a touch display driver 22, a sensor driver 23, an operation switch 24, and touch sensors 30U, 30D, 30L, and 30R. In a case in which it is not necessary to explain each of the touch sensors 30U, 30D, 30L, and 30R, separately, the respective touch sensors 30U, 30D, 30L, and 30R are collectively referred to as “touch sensor 30 (second sensor unit)”.

The display driver 18, for example, outputs to the display unit 20 an image signal for displaying information such as characters and images while executing various functions based on control of the CPU 11.

The display unit 20 includes a display panel of light emitting element type such as liquid crystal type that allows color display and monochrome display, organic EL, and the like, for example. Then, as shown in FIG. 1A, in a display area of the display unit 20, a plurality of menu icons 21 (hereinafter, referred to as “icon”) and the like associated with various functions at least executed at the input device 100 is arranged and displayed in a two-dimensional manner and in a matrix (a row direction and column direction), for example. Furthermore, on the display unit 20, predetermined character information and image information in response to the functions are displayed along with the display of the icons 21 while executing various functions.

As shown in FIGS. 1A and 1B, the touch sensors 30U, 30D, 30L, and 30R extend along lateral sides of at least two different directions among lateral sides of the outer circumference of the housing 10 and are provided so as to be spaced away from each other. The touch sensor 30 is provided at an area that does not overlap the display area of a touch display sensor 19 (described later) and detects a position at which an object such as a fingertip of a human body or a stylus touches or approaches.

As shown in FIG. 1A, the touch sensor 30U is provided along a left-right direction of the display area at a lateral side of the upper side of FIG. 1A among the lateral sides of the outer circumference of the housing 10 having a rectangular outline shape. Furthermore, the touch sensor 30D is provided along a direction parallel to the touch sensor 30U at a lateral side of the lower side of FIG. 1A. Similarly, as shown in FIG. 1A, the touch sensor 30L is provided along the vertical direction of the display area at a lateral side of FIG. 1A among the lateral sides of the outer circumference of the left side of FIG. 1A among the lateral sides of the outer circumference of the housing 10 having a rectangular outline shape. Furthermore, the touch sensor 30R is provided along a direction parallel to the touch sensor 30L at a lateral side of the right side of FIG. 1A.

The sensor driver 23, for example, outputs a detection signal indicating touch positions based on a change in capacitance generated by a human body (a finger in the present embodiment) touching these touch sensors 30U, 30D, 30L, and 30R. The detection signal is used for operational control of an input operation at the CPU 11 (described later) after being temporarily stored in the Flash memory 14.

More specifically, as shown in FIG. 3A, for example, the touch sensor 30 has a configuration in which a pair of electrodes 31 and 32 respectively having planar sliding-door shape is arranged so as to be reversed to face each other. Then, when the finger (finger FG) is in touch with both of the pair of electrodes 31 and 32, the capacitance generated according to the shape of the electrode is detected by the sensor driver 23, and thus a touch position at which the human body is touched is detected by the ratio of the capacitance. The touch sensors 30U and 30D consisting of such a pair of electrodes 31 and 32 are arranged so as to extend at an end face of the outer circumference in a direction facing each other (in the present embodiment, the left-right direction) of the housing 10 surrounding the outer circumference of the display unit 20. Similarly, the touch sensors 30L and 30R consisting of such a pair of electrodes 31 and 32 are arranged so as to extend to an end face of the outer circumference in a direction facing each other (in the present embodiment, the vertical direction) of the housing 10 surrounding the outer circumference of the display unit 20. With such a configuration, it is possible to instruct to perform an input operation on the display area of the display unit 20 based on a detection signal indicating a touch position in the left-right direction or the vertical direction.

Furthermore, for the touch sensor 30 that can be applied to the present embodiment, as shown in FIG. 3B, it may be configured so as to arrange in series a plurality of electrodes 33 with constant intervals along the end face of the outer circumference of the housing 10. When a finger of a human body (not shown) touches with the electrode 33 on the touch sensor 30, the capacitance generated at each electrode 33 is detected by the sensor driver 23 and a touch position of the human body is detected based on the size of the capacitance detected at adjacent electrodes 33.

Furthermore, the touch sensor 30 that can be applied to the present embodiment, as shown in FIG. 3C, for example, may be the hybrid type of FIGS. 3A and 3B that is configured so that a plurality of electrodes 34 having a planar shape of a parallelogram is arranged so as to overlap in series with constant intervals along the end face of the outer circumference of the housing 10. When a finger of a human body (not shown) touches with the electrode 34 on the touch sensor 30, the capacitance generated at each electrode 34 is detected by the sensor driver 23 and a touch position of the human body is detected based on the magnitude of the capacitance detected at adjacent electrodes 33.

The touch sensors 30U and 30D perform an input operation such as movement on an image such as an arbitrary icon displayed in the display area by moving (sliding) in the left-right direction in a state of being held by a finger of the human body at an upper side face and a lower side face of the display area of the display unit 20. Therefore, the touch sensors 30U and 30D may be acceptable so long as being arranged so as to extend along an identical direction at least in the vertical direction around the display unit 20.

Similarly, the touch sensors 30L and 30R perform an input operation such as moving to an image such as an arbitrary icon displayed in the display area by moving (sliding) in the vertical direction in a state of being held by a finger of the human body at a left side face and a right side face of the display area of the display unit 20. Therefore, the touch sensors 30L and 30R may be acceptable so long as being arranged so as to extend along an identical direction at least in the left-right direction around the display unit 20.

The touch display sensor (first sensor portion) 19 has a touch screen that is arranged on a front face side (viewing field side) of the display area (display screen) of the display unit 20 or is integrally formed on the front face side. The touch display sensor 19 is provided by being layered on the display area and detects a position at which an object such as a fingertip of a human body or a stylus touches or approaches. The touch display sensor 19 may be one that has a function equivalent to a function that is realized in an input operation using the abovementioned touch sensor 30, or may be one that has a specific function that is different from a function realized in the touch sensor 30. For example, regarding the touch screen, it is possible to realize a function equivalent to that of the abovementioned touch sensor 30 by a user directly touching the display area. Here, in a case in which the touch screen has a display area of small size such as the input device 100 according to the present embodiment, the touch screen can be effectively adapted to an input operation in a case in which a relatively large icon is displayed thereon.

The touch display driver 22, for example, outputs a detection signal indicating touch positions based on the change in capacitance generated by a human body (a finger in the present embodiment) touching these touch display sensors 19.

It should be noted that, if all of the functions of the input device 100 can be realized with solely the touch sensor 30 according to the present embodiment, it may have a configuration which omits (does not include) the touch display sensor 19 on the touch screen, push buttons, or the like.

Through execution of processing according to programs stored in the ROM 12, the CPU 11 controls a display operation of an icon and other pieces of information on the display unit 20, an operation to detect a position of a finger of a user touching the touch sensor 30, an operation to select an arbitrary icon 21 from among a plurality of icons 21 arranged in a matrix to be displayed on the display unit 20 and to execute a predetermined function associated with the icon 21. It should be noted that this program may be incorporated into the CPU 11 in advance.

The ROM 12 stores a program for realizing a predetermined function in each element of the input device 100 (the display unit 20, the sensor driver 23, and the like), a program for realizing an operation control according to an input operation (described later), and the like. In the RAM 13, data is temporarily stored which is generated by executing the abovementioned programs or is referred to such as a predetermined kind of input contents corresponding to each combination of a detection result of a sensor. The Flash memory 14 includes non-volatile memory and stores data associated with a touch position detected by the abovementioned touch sensor 30 and the sensor driver 23. It should be noted that a portion of the non-volatile memory constituting the Flash memory 14 may be one that is configured so as to have a removable storage medium such as a memory card and to be detachable from the input device 100.

The electric power supply IC 15 controls to supply or block driving electric power to each element of the input device 100 through the operation of the electric power supply switch 16 or based on an instruction from the CPU 11. The electric power supply IC 15, for example, includes a primary cell such as a coin-type cell and a button-type cell and a secondary cell such as a lithium-ion cell and a nickel-hydrogen cell that are commercially available. It should be noted that an electric power supply according to energy harvesting technology that produces electric power by oscillation, light, heat, electromagnetic wave, and the like is applicable as well. Here, for the electric power switch 16, a push button or the like can be adapted, for example. Similarly, the operation switch 24 has a push button and the like provided at a lateral side or a front face of the housing 10.

The GPIO 17 has a connection function for transmitting and receiving data with a device provided externally to the input device 100. More specifically, the GPIO 17 transmits data for backup of data stored in the Flash memory 14, version upgrade of functions implemented by programs, or the like by way of connecting with a personal computer or the like.

### Input Method

Next, an input method for an input device according to the present embodiment is described. Here, a case of operating an input device with the right hand is described. It should be noted that operation control of a sequence of the input method as shown below is realized by executing a predetermined program in the abovementioned CPU 11.

Next, a case is described of moving (scrolling) an image displayed on a display area in the right direction or in the left direction by way of using an arbitrary finger of the right hand of a user in a state of displaying images such as a plurality of icons 21 and the like on the display unit 20 of the input device 100.

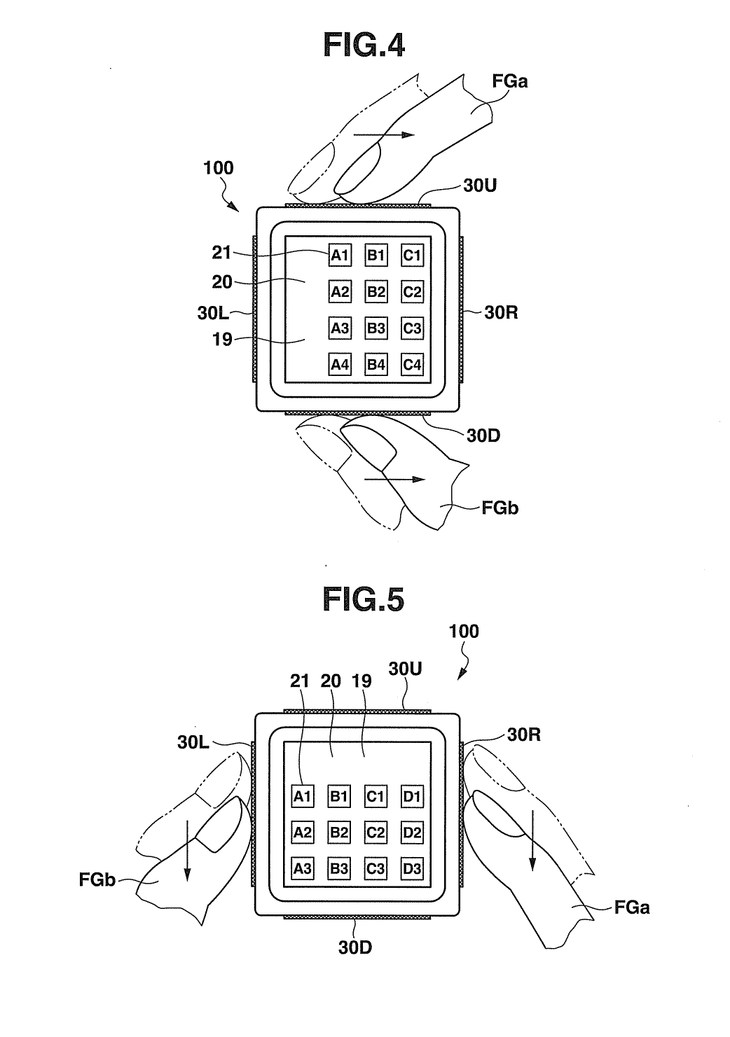

FIG. 4 is a schematic diagram showing an example of an input method applied to an input device according to the present embodiment.

More specifically, the display area is held in the vertical direction by touching an index finger FGa of the right hand of a user on the touch sensor 30U that extends in the left-right direction at the upper side of the display area and by touching the thumb FGb of the right hand on the touch sensor 30D that extends in the left-right direction at the lower side of the display area. In this way, the sensor driver 23 detects the touch position of the index finger FGa on the touch sensor 30U and the touch position of the thumb FGb on the touch sensor 30D. In a case of being a combination in which a touch position that is detected at the touch sensor 30U and a touch position that is detected at the touch sensor 30D moves in the right direction, the CPU 11 executes processing of scrolling an image displayed on the display area in the right direction. As a result, as shown in FIG. 4, the CPU 11 executes control of scrolling the image displayed on the display area in the display unit 20 via the display driver 18 in the right direction. Furthermore, although not illustrated, in a case of being a combination in which touch positions that is detected at the touch sensor 30U and a touch position that is detected at the touch sensor 30D move in the left direction, the CPU 11 executes processing of scrolling an image displayed on the display area in the left direction. As a result, the CPU 11 executes control of scrolling the image displayed on the display area in the display unit 20 via the display driver 18 in the left direction.

Next, a case is described of scrolling an image displayed on the display area in a down direction or in an up direction using an arbitrary finger of the user's right hand with an image such as a plurality of icons 21, etc. displayed on the display unit 20 of the input device 100.

FIG. 5 is a schematic diagram showing an example of an input method applied to an input device according to the present embodiment.

More specifically, the display area is held in the left-right direction by touching an index finger FGa of the right hand of a user on the touch sensor 30R that extends in the vertical direction at the right side of the display area and by touching the thumb FGb of the right hand on the touch sensor 30L that extends in the vertical direction at the left side of the display area. In this way, the sensor driver 23 detects the touch position of the index finger FGa on the touch sensor 30R and the touch position of the thumb FGb on the touch sensor 30L. In a case of being a combination in which a touch position that is detected at the touch sensor 30R and a touch position that is detected at the touch sensor 30L move in the lower direction, the CPU 11 executes processing of scrolling an image displayed on the display area in the down direction. As a result, as shown in FIG. 5, the CPU 11 executes control of scrolling the image displayed on the display area at the display unit 20 via the display driver 18 in the right direction. Furthermore, although not illustrated, in a case of being a combination in which touch positions that is detected at the touch sensor 30R and a touch position that is detected at the touch sensor 30L move in the upper direction, the CPU 11 executes processing of scrolling an image displayed on the display area in the up direction. As a result, the CPU 11 executes control of scrolling the image displayed on the display area in the display unit 20 via the display driver 18 in the up direction.

Next, a case is described of rotating an image displayed on the display area using an arbitrary finger of the user's right hand with an image such as a plurality of icons 21 etc. displayed on the display unit 20 of the input device 100.

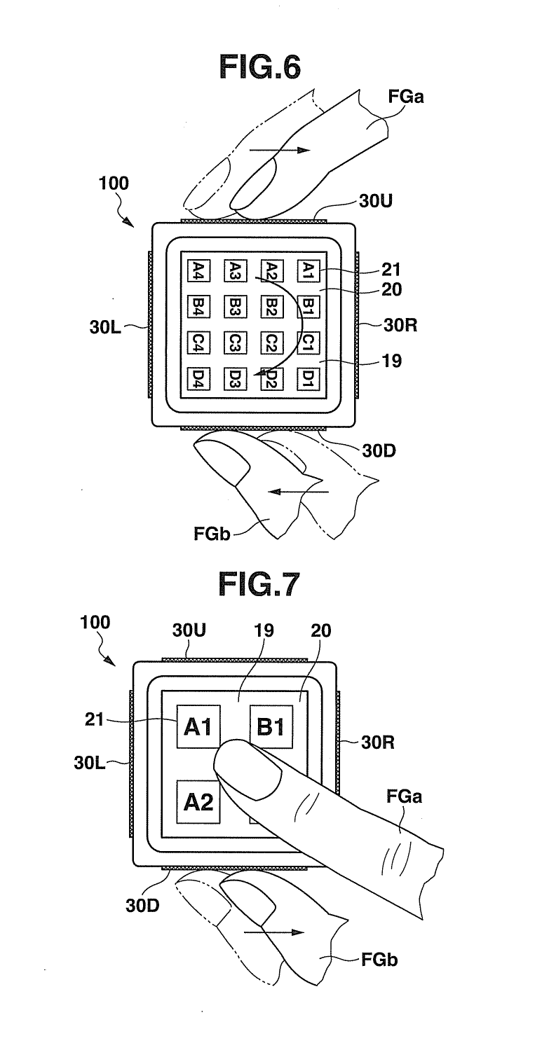

FIG. 6 is a schematic diagram showing an example of an input method applied to an input device according to the present embodiment.

More specifically, the display area is held in the vertical direction by touching an index finger FGa of the right hand of a user on the touch sensor 30U that extends in the left-right direction at the upper side of the display area and by touching the thumb FGb of the right hand on the touch sensor 30D that extends in the left-right direction at the lower side of the display area. In this way, the sensor driver 23 detects the touch position of the index finger FGa on the touch sensor 30U and the touch position of the thumb FGb on the touch sensor 30D. In a case of being a combination in which a touch position that is detected at the touch sensor 30U moves in the right direction and a touch position that is detected at the touch sensor 30D moves in the left direction, the CPU 11 executes processing of rotating an image displayed on the display area in the right direction (in a clockwise direction). As a result, as shown in FIG. 6, the CPU 11 executes control of rotating the image displayed on the display area in the display unit 20 via the display driver 18 in the right direction. Furthermore, although not illustrated, in a case of being a combination in which the touch position that is detected at the touch sensor 30U moves in the left direction and the touch position that is detected at the touch sensor 30D moves in the right direction, the CPU 11 executes processing of rotating an image displayed on the display area in the left direction (in an anti-clockwise direction). As a result, the CPU 11 executes control of rotating the image displayed on the display area in the display unit 20 via the display driver 18 in the left direction.

Similarly, although not illustrated, the display area is held in the left-right direction by touching an index finger FGa of the right hand of a user on the touch sensor 30R that extends in the vertical direction at the right side of the display area and by touching the thumb FGb of the right hand on the touch sensor 30L that extends in the vertical direction at the left side of the display area. In this way, the sensor driver 23 detects the touch position of the index finger FGa on the touch sensor 30R and the touch position of the thumb FGb on the touch sensor 30L. In a case of being a combination in which a touch position that is detected at the touch sensor 30R moves in the down direction and a touch position that is detected at the touch sensor 30L moves in the up direction, the CPU 11 executes processing of rotating an image displayed on the display area in the right direction (in a clockwise direction). As a result, the CPU 11 executes control of rotating the image displayed on the display area in the display unit 20 via the display driver 18 in the right direction. Furthermore, in a case of being a combination in which the touch position that is detected at the touch sensor 30R moves in the upper direction and the touch position that is detected at the touch sensor 30L moves in the lower direction, the CPU 11 executes processing of rotating an image displayed on the display area in the left direction (in an anti-clockwise direction). As a result, the CPU 11 executes control of rotating the image displayed on the display area at the display unit 20 via the display driver 18 in the left direction.

Next, a case is described of displaying an image to be enlarged or reduced that is displayed on the display area using an arbitrary finger of the user's right hand with an image such as a plurality of icons 21, etc. displayed on the display unit 20 of the input device 100.

FIG. 7 is a schematic diagram showing an example of an input method applied to an input device according to the present embodiment.

More specifically, among the display areas on the touch display sensor 19, a user causes a right hand index finger FGa to touch any position of an area desired to be displayed to be enlarged or reduced, as well as causing a right hand thumb FGb to touch the touch sensor 30D extending in the left-right direction below the display area. In this way, the sensor driver 23 detects the touch position of the index finger FGa on the touch display sensor 19 and the touch position of the thumb FGb on the touch sensor 30D. In a case of being a combination in which a touch position that is detected at the touch sensor 30D moves in the right direction, the CPU 11 executes processing to cause an image being displayed in the display area to be displayed to be enlarged, centering at any position detected at the touch display sensor 19. As a result, as shown in FIG. 7, the CPU 11 executes control of displaying the image displayed on the display area at the display unit 20 via the display driver 18 to be displayed to be enlarged, centering at a touch position of the index finger FGa on the touch display sensor 19. Furthermore, although not illustrated, in a case of being a combination in which the touch position that is detected at the touch sensor 30D moves in the left direction, the CPU 11 executes processing to cause an image being displayed in the display area to be displayed to be reduced, centering at any position detected on the touch display sensor 19. As a result, the CPU 11 executes control of displaying the image displayed on the display area in the display unit 20 via the display driver 18 to be displayed to be reduced, centering at a touch position of the index finger FGa on the touch display sensor 19.

### Verification of Operational Effect

Next, an operational effect of an input device and an input method according to the present embodiment is described in detail.

First, a conventional input device and an input method (not illustrated) has a display unit, a touch screen that is arranged on a front face side (viewing field side) of the display area or is integrally formed, and a housing in which the display unit and the touch screen are provided at one face side. In other words, the input device 100 shown in the present embodiment (refer to FIG. 1) has a configuration for performing scrolling of an icon and a menu and displaying them to be enlarged or reduced, displayed on a touch screen provided at a front face of the display unit, without the touch sensors 30U, 30D, 30L, and 30R at the lateral sides of the housing 10.

A case is observed in which multiple icons are arranged on a display unit (for example, arranged in a 4×4 matrix) and a desired function is executed by selecting an arbitrary icon from among the multiple icons, in such a conventional input device (not illustrated). In such a case, when a user intends to perform an input operation such as moving (scrolling), displaying to be enlarged, rotating, etc. an image by touching with a finger an area in which an image such as an arbitrary icon is displayed, the area including the icon etc. is hidden behind the finger, so that a problem arises in that it becomes impossible to recognize what kind of state an image such as a desired icon etc. is in. Furthermore, a problem arises in that an input operation that a user does not intend may be performed if an image such as an icon is moved, enlarged, rotated, or the like due to a finger or an object simply touches with an area in which an image such as an icon is displayed.

Incidentally, a method of manipulating an image such as an arbitrary icon, etc. by way of a stylus, etc. without using a finger is considered as a way of avoiding such a problem. However, in such a case, since it is necessary to carry a stylus, etc. constantly and pick up the stylus to perform an input operation whenever necessary, a problem also arises in that portability and operability of an electronic device degrade greatly. Furthermore, if such an input device is applied to an exercise supporting terminal, etc. that is attached to a body during exercise, a problem arises in that it becomes difficult to arbitrarily manipulate an image such as a desired icon.

However, in the input device and the input method according to the present embodiment, as shown in FIG. 1, by causing different fingers of a user to touch with a predetermined combination to the touch display sensor 19 provided by being layered on the display area of the display unit 20 as well as the plurality of touch sensors 30U, 30D, 30L, and 30R that is provided at an area which does not overlap the display area of the display unit 20 and detects a position where a finger touches or approaches, the touch positions of the fingers are detected and the combination of the touch positions are detected as well. Furthermore, when the user causes the touch positions of the fingers to move, control is executed to input an operational content of a kind corresponding to a detection result, a result of which an image such as an icon displayed in a display area is displayed to be scrolled, enlarged, or rotated, etc.

Therefore, according to the present embodiment, in the input device 100 having a relatively small display unit 20, by operating the touch display sensor 19 or at least two sensors among the touch sensors 30U, 30D, 30L, and 30R provided at the lateral sides of the outer circumference of the housing 10, it is possible to easily manipulate an image such as multiple icons 21, etc. arranged in a matrix on a display area, a result of which a fingertip is not located at a front face of the display unit 20 so that the fingertip no longer obstructs the user's field of vision. With such a configuration, it is possible to execute a desired input operation reliably while maintaining visibility. Furthermore, since it is also possible to avoid an image such as icons from being moved, enlarged, or rotated by a finger or an object simply touches an area in which the image such as of icons is displayed, an input operation that a user does not intend is not executed. Furthermore, since it is not necessary to carry a stylus or the like constantly for an input operation, the portability and operability of an electronic device mounted with the input device 100 according to the present embodiment do not degrade. Moreover, even in a case of applying the input device 100 according to the present embodiment to an exercise supporting terminal and the like attached to a body during exercise, it is possible to execute a desired function by selecting precisely an arbitrary icon while exercising such as running.

### Another Example of Input Device

Next, other configuration examples (modified examples) of an input device according to the abovementioned embodiment are described.

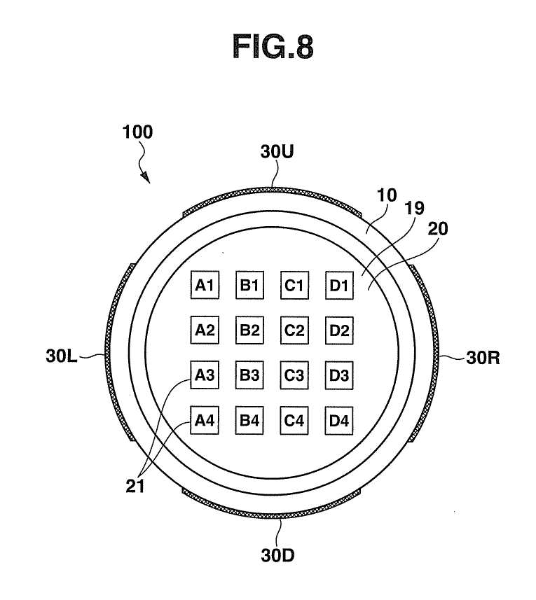

FIGS. 8 to 10 are schematic diagrams showing other configuration examples of an input device according to the present embodiment. Explanations for configurations that are the same as those of the abovementioned embodiment are omitted here.

In the abovementioned embodiment, explanations are provided for the input device 100 having a configuration in which: the touch display sensor 19 provided by being layered at the display area of the display unit 20 provided at the housing 10 having a rectangular outer shape; the touch sensors 30L and 30R that are provided at an area that does not overlap the display area of the display unit 20, face each other interposing the display area, and extend in the left-right direction with respect to the display area; and the touch sensors 30U and 30D that extend in the vertical direction with respect to the display area are provided. However, the present invention is not limited thereto, and may be applied to various modified examples such as the modified examples shown below.

### First Modified Example

A first modified example of the input device according to the present embodiment, as shown in FIG. 8, has a configuration in which a touch display sensor 19 provided by being layered at a display area of a display unit 20 provided at a housing 10 having a circular outer shape, and touch sensors 30U, 30D, 30L, and 30R that extend along a lateral side of an outer circumference of the housing 10 are provided. In other words, the touch sensors 30U, 30D, 30R, and 30L are provided along a circumferential face at an upper side, at a lower side, at a right side, and at a left side, respectively, in the drawings of the housing 10 having a shape similar to a frame of a circular watch main body applied to a general wrist watch.

In the input device 100 having such a configuration, as shown in FIG. 8, for example, by touching an index finger (not illustrated) of a user on the touch sensor 30U and touching a thumb of the user (not illustrated) on the touch sensor 30D, a sensor driver 23 detects a touch position of the index finger FGa on the touch sensor 30U and a touch position of the thumb FGb on the touch sensor 30D. The CPU 11 executes control to input by reading from the RAM 13 an operational content of a kind corresponding to a combination corresponding to a combination of the touch positions detected at the touch sensors 30U and 30D. As a result of this, in a case in which the touch positions detected at the touch sensors 30U and 30D move in the same direction together, processing is executed of scrolling an image displayed in a display area in the moving direction of the touch position, a result of which the image displayed in the display area is scrolled in the left direction. Furthermore, in a case in which the touch positions detected at the touch sensors 30U and 30D move in the opposite directions, processing is executed of rotating the image displayed in the display area in a right or left direction, a result of which the image displayed in the display area is displayed to be rotated.

Since in such a modified example as well, by operating the touch display sensor 19 or at least two sensors among the touch sensors 30U, 30D, 30L, and 30R provided at the lateral side of the outer circumference of the housing 10, it is possible to easily manipulate an image such as multiple icons 21 that are arranged in a matrix on the display area, a fingertip is not located at a front face of the display unit 20 so that the fingertip no longer obstructs the user's field of vision. With such a configuration, it is possible to execute a desired input operation reliably while maintaining visibility. Furthermore, since it is also possible to avoid an image such as of icons from being moved, enlarged, or rotated by a finger or an object simply touches an area in which the image such as icons is displayed, an input operation that a user does not intend is not executed. Furthermore, since it is not necessary to carry a stylus or the like constantly for an input operation, the portability and operability of an electronic device mounted with the input device 100 according to the present embodiment do not degrade. Moreover, even in a case of applying the input device 100 according to the present embodiment to an exercise supporting terminal and the like attached to a body during exercise, it is possible to execute a desired function by selecting precisely an arbitrary icon while exercising such as running.

### Second Modified Example

In the abovementioned embodiment, the input device 100 having a configuration in which only the touch sensors 30U and 30D are provided at the lateral side of the outer circumference of the housing 10 having a rectangular outer shape is described. However, the present invention is not limited thereto, and may be applied to a housing 10 in which an operation switch 24 or a GPIO 17 is provided at a lateral face of the outer circumference, as described below.

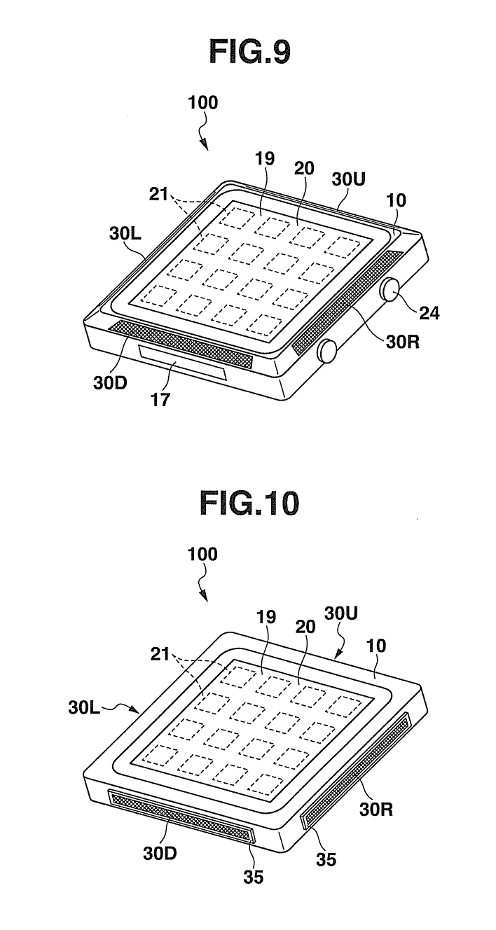

For a second modified example of an input device according to the present embodiment, the input device 100 shown in the abovementioned embodiment, as shown in FIG. 9, has a configuration in which, for example, a press button that is a kind of the operation switch 24 and a connector used as the GPIO 17 are provided at lateral sides of the outer circumference in different two directions of the housing 10, and touch sensors 30U, 30D, 30L, and 30R are provided at a tilt face provided between the lateral face of the outer circumference and the display unit 20.

In such a modified example as well, a fingertip is not located at a front face of the display unit 20 while performing an input operation to an image such as icons 21, etc., so that the fingertip no longer obstructs the user's field of vision, a result of which it is possible to execute a desired input operation reliably while maintaining visibility. Furthermore, since it is not necessary to modify the arrangement of the existing touch display sensor 19 or the GPIO 17, it is possible to suppress the increase in cost due to a design change or modification of the production process.

### Third Modified Example

For a third modified example of an input method according to the present embodiment, the input device 100 shown in the abovementioned embodiment, as shown in FIG. 10, has a configuration in which tactile switches 35, which are press-button type operational switches, are provided so as to project at lateral sides of the outer circumference in four different directions of a housing 10, respectively, and touch sensors 30U, 30D, 30L, and 30R are provided at projecting faces of the tactile switches 35, respectively. The tactile switch 35 refers to a switch that gives a certain feeling back to a user who touches the switch with the user's finger and is conducts electricity by the user pushing the tactile switch 35 by a finger, so that an electric signal can be sent to the CPU 11. In the input device 100 having such a configuration, similarly to the abovementioned embodiment, the user touches one of the touch sensors 30U, 30D, 30L, and 30R with two fingers, respectively, (for example, the index finger and thumb) (not illustrated), and then touch positions of the fingers on the touch sensors that the user's fingers touched, respectively, from among the touch sensors 30U, 30D, 30L, and 30R are detected.

Then, in a state in which the user's fingers are in touch with touch sensors, respectively, from among the touch sensors 30U, 30D, 30L, and 30R, by pushing the tactile switches 35 with both fingers simultaneously or sequentially, or by moving touch positions of the fingers in a state in which the tactile switch 35 is pushed by either finger, control is executed of inputting an operational content of a kind corresponding to a result of movements of the fingers, a result of which displaying by scrolling, enlarging, rotating, or the like an image such as icons displayed on a display area is executed.

In such a modified example as well, a fingertip is not located at a front face of the display unit 20 while performing an input operation to an image such as icons 21, etc., so that the fingertip no longer obstructs the user's field of vision, a result of which it is possible to execute a desired input operation reliably while maintaining visibility. Furthermore, according to the present modified example, since it is possible to acquire actual feeling of a switch operation by performing an operation of moving a finger in a state of the tactile switch 35 being pushed with a finger, a desired input operation can be executed reliably, a result of which the operability of the input device 100 can be improved.

### Electronic Device

Next, an electronic device to which the input device and the input method described in each of the abovementioned embodiments can be applied is described.

The input device 100 described in the abovementioned embodiment can be preferably utilized as an input device for various electronic devices such as an audio-dedicated device, a wrist watch type communication terminal, and an exercise supporting terminal.

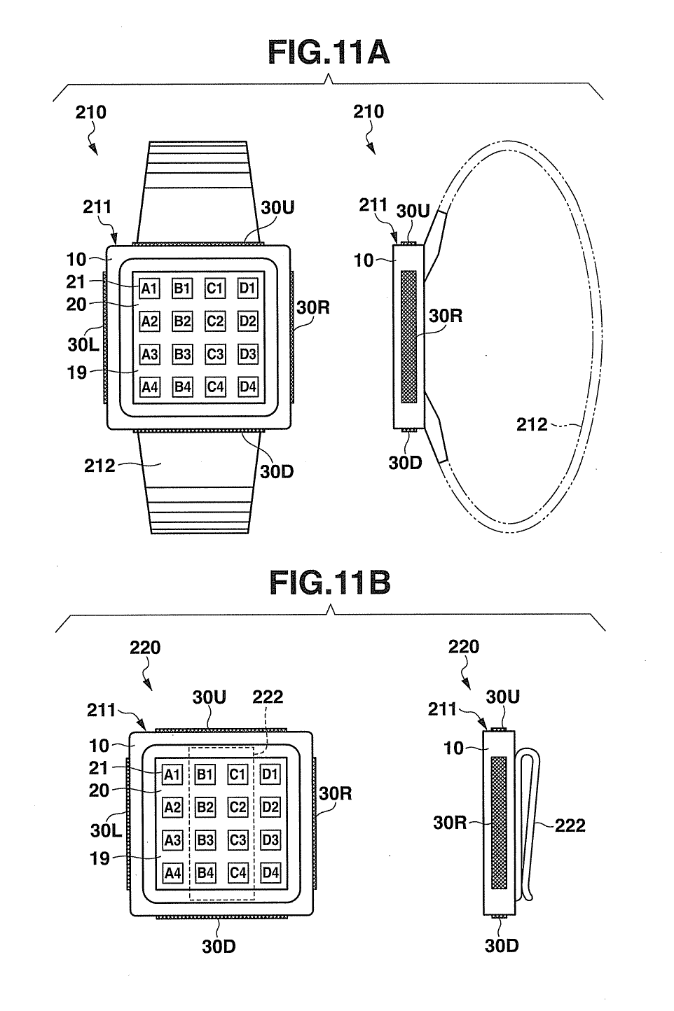

FIG. 11 is a schematic configuration diagram showing an example of an electronic device to which an input device according to the present invention is applied. The same reference numerals are assigned to configurations similar to those in the abovementioned embodiments and the descriptions thereof are omitted.

As shown in FIG. 11A, an electronic device 210 to which the present invention is applied is a wrist watch type communication terminal or an exercise supporting terminal that is used by a user wearing on a wrist (body), and generally has a device main body 211 mounted with the input device 100 described in the abovementioned embodiments and a belt portion 212 for attaching the device main body 211 on a user′ wrist. In the electronic device 210 having such a configuration, by a user operating touch sensors 30U, 30D, 30L, and 30R provided at lateral faces of an outer circumference of a housing 10 with fingers, respectively, (for example, the index finger and thumb of the right hand) in a state of the device being attached to the body (for example, the left wrist) by way of the belt portion 212, it is possible to easily execute a desired input operation on an image such as a plurality of icons 21 displayed on a display unit 20.

As shown in FIG. 11B, an electronic device 220 to which the present invention is applied is a clip-type audio-dedicated device, and generally has a device main body 221 mounted with the input device 100 described in the abovementioned embodiments and a clip portion 222 for attaching the device main body 221 to a cloth, a belt, or the like. In the electronic device 220 having such a configuration, by a user operating touch sensors 30U, 30D, 30L, and 30R provided at lateral faces of an outer circumference of the housing 10 with another finger, respectively, in a state of the device being attached to clothes, a belt, or the like by way of the clip portion 222 provided at a back face of the device main body 221, it is possible to easily execute a desired input operation on an image such as a plurality of icons 21 displayed on a display unit 20.

Therefore, by applying the input device 100 according to the present invention to the abovementioned electronic devices 210, 220, a fingertip is not located at a front face of the display unit 20 so that the fingertip no longer obstructs the user's field of vision, a result of which it is possible to execute a desired input operation reliably while maintaining visibility, and thus the operability of the electronic devices 210, 220 can be improved.

As described above, the input device 100 to which the present invention is applied can take forms of various embodiments such as following configurations including the abovementioned embodiments.

The input device 100 includes the display unit 20, the touch display sensors 19, the touch sensor 30, and the CPU 11.

The display unit 20 has a display area. The touch display sensor 19 is provided to be layered on the display area and detects a position where an object touches or approaches. At least one touch sensor 30 is provided at an area that does not overlap the display area and detects a position where an object touches or approaches. In the RAM 13, predetermined kinds of input content are stored to be respectively associated with combinations of detection results of at least two sensors from among the touch display sensors 19 and at least one touch sensor 30, and the CPU 11 acquires detection results from the touch display sensor 19 and at least one touch sensor 30, respectively, and executes control to read from the RAM 13 and input an operational content of a kind corresponding to a detection result thus acquired. Such a configuration allows a user to readily perform a desired input operation without degrading operability of a smaller electronic device.

Furthermore, the touch sensor 30 of the input device 100 includes the touch sensor 30U and the touch sensor 30D that face each other interposing the display area and respectively extend in a first direction (for example, in the left-right direction) with respect to the display area. Then, for a combination in which a position detected at the touch sensor 30U and a position detected at the touch sensor 30D move in a first direction (for example, in the left direction) together, an operational content of scrolling an image displayed on the display area in the movement direction (for example, in the left direction) is associated. With such a configuration, in the input device 100 including the display unit 20 of relatively small size, since by simply moving at the touch sensors 30U, 30D in a desired direction, it is possible to easily scroll an image such as icons 21 and the like displayed on the display area in the left-right direction, a fingertip is not located at a front face of the display unit 20 so that the fingertip no longer obstructs the user's field of vision. With such a configuration, it is possible to execute a desired input operation reliably while maintaining visibility.

Furthermore, for the input device 100, with regards to the combination in which the movement direction of the position detected by the touch sensor 30U and the movement direction of the position detected by the touch sensor 30D are opposite, an operational content of a kind that rotates an image displayed on a display area from in a first direction (for example, in the left direction) to in a second direction (for example, in the right direction). With such a configuration, since it is possible to easily rotate an image such as icons 21 and the like displayed on the display area in a desired direction by performing an operation so as to rotate the image by moving fingers in a desired direction on the touch sensors 30U and 30D at the input device 100 having the display unit 20 of relatively small size, such as by pinching the input device 100, a fingertip is not located at a front face of the display unit 20 so that the fingertip no longer obstructs the user's field of vision. With such a configuration, it is possible to execute a desired input operation reliably as well as intuitively while maintaining visibility.

Furthermore, the touch sensor 30 of the input device 100 includes the touch sensor 30L and the touch sensor 30R that face each other interposing the display area and respectively extend in a second direction (for example, in a vertical direction) perpendicular to a first direction (for example, in the left-right direction) with respect to the display area. Then, for a combination in which a position detected at the touch sensor 30L and a position detected at the touch sensor 30R move in the second direction (for example, in the vertical direction) together, an operational content of scrolling an image displayed on the display area in the second direction (for example, in the vertical direction) is associated. With such a configuration, in the input device 100 including the display unit 20 of relatively small size, since by simply moving fingers at the touch sensors 30L, 30R in a desired direction, i.e. by pinching and pulling the input device 100, it is possible to easily scroll an image such as icons 21 and the like displayed on the display area in the vertical direction, a fingertip is not located at a front face of the display unit 20 so that the fingertip no longer obstructs the user's field of vision. With such a configuration, it is possible to execute a desired input operation reliably as well as intuitively while maintaining visibility.

Furthermore, for the input device 100, with regards to the combination in which the moving direction of the position detected by the touch sensor 30L and the moving direction of the position detected by the touch sensor 30R are opposite, an operational content of a kind that rotates an image displayed on a display area from in a third direction (for example, in the upper direction) to in a fourth direction (for example, in the lower direction). With such a configuration, since it is possible to easily rotate an image such as icons 21 and the like displayed on the display area in a desired direction by performing an operation so as to rotate the image by moving fingers in a desired direction on the touch sensors 30L and 30R at the input device 100 having the display unit 20 of relatively small size, such as by pinching the input device 100, a fingertip is not located at a front face of the display unit 20 so that the fingertip no longer obstructs the user's field of vision. With such a configuration, it is possible to execute a desired input operation reliably as well as intuitively while maintaining visibility.

Furthermore, in a state in which a position is being detected at the touch display sensor 19, for a combination in which a position detected at the touch sensor 30U or 30D moves in the first direction (for example, in the left direction) or in the second opposite direction (for example, in the right direction), in a case in which the movement of the position detected at the touch sensor 30D is the first direction (for example, the left direction), an operational content of a kind so that an image displayed in the display area is displayed to be enlarged is associated, and in a case in which the movement of the position detected at the touch sensor 30D is the second direction (for example, the right direction), an operational content of a kind so that an image displayed in the display area is displayed to be reduced is associated. With such a configuration, in the input device 100 including the display unit 20 of relatively small size, since by simply moving fingers at the touch sensors 30L, 30R in a desired direction, i.e. by pinching and pulling the input device 100, it is possible to easily display an image, such as icons 21 and the like, to be enlarged or reduced to a desired size, a fingertip is not located at a front face of the display unit 20 so that the fingertip no longer obstructs the user's field of vision. With such a configuration, it is possible to execute a desired input operation reliably while maintaining visibility.

Furthermore, the abovementioned input device 100 is mounted to the electronic devices 210 and 220. With such a configuration, since a fingertip is not located at a front face of the display unit 20 while performing an input operation or the like on an image such as icons 21 and the like, so that the fingertip no longer obstructs the user's field of vision, it is possible to execute a desired input operation reliably while maintaining visibility, a result of which the operability of the electronic devices 210 and 220 can be improved.

It should be noted that, in each embodiment described above, although the configuration of providing the touch sensors 30U, 30D, 30L, and 30R at the lateral sides of the outer circumference of the housing 10 of the input device 100 is described, the present invention is not limited thereto. The present invention may be any configuration so long as enabling to perform a predetermined operation such as scrolling, rotating, enlarging, and the like on an image displayed on the display area by way of the touch sensors 30U, 30D, 30L, and 30R that are provided at an area that does not overlap the display area of the display unit 20. Therefore, the present invention may include, for example, a configuration in which the touch sensors 30U, 30D, 30L, and 30R are provided on the same plane as that of the display area of the display unit 20 but at an outer circumferential area thereof (a so-called frame area) or a configuration in which the touch sensors 30U, 30D, 30L, and 30R are provided at an area proximal to an outer edge portion within the display area.

Furthermore, in each embodiment as described above, although the input operation of selecting an arbitrary icon 21 from among the plurality of icons 21 arranged and displayed in a matrix on the display area and realizing a predetermined function associated with the icon 21 are described, the present invention is not limited thereto. For example, the present invention may include a configuration in which, in a case of applying the input device 100 according to the present invention to an audio-dedicated device or the like, for example, an icon of arbitrary music is selected and replayed by way of the abovementioned input method, and furthermore, a function for volume adjustment is realized by sliding a finger along the extending direction of the touch sensors 30U, 30D, 30L, or 30R.

Furthermore, the present invention may include a configuration in which, for example, a function of displaying an image, such as an icon 21, on an entire display area is realized by storing a plurality of pieces of image data, etc. in the Flash memory 14, displaying a reduced image thereof on the display area as an icon 21, and selecting an arbitrary icon 21 by moving a cursor displayed on the display area.

It should be noted that the input device 100 described in each embodiment as described above has a configuration in which any of the arbitrary touch sensors 30U, 30D, 30L, and 30R is exposed on a lateral side of the outer circumference of the housing 10. For this reason, in an electronic device to which such an input device 100 is applied, when a part of a human body or an electrically conductive member such as of metal, etc. may be touched with the touch sensors 30U, 30D, 30L, and 30R unintentionally, it may cause an unwanted operation. Furthermore, a portable electronic device may be often lost or misplaced, a result of which personal information and the like is likely to be leaked to other people operating the device.

In order to avoid such a problem occurring, it is desirable to activate a lock function automatically or arbitrarily by a user after a predetermined lapse of time after the finish of the operation of the electronic device so as to inhibit an input operation. Here, as a method for activating a lock function by a user, it may be configured to employ a method to activate the lock function on the condition that, for example, an icon associated with the lock function is selected or on the condition that an unlock operation of the lock function within a specific period of time is registered. On the other hand, for a method for unlocking the lock function, it may be configured to employ a method for unlocking by performing a specific operation to the touch sensors 30U, 30D, 30L, and 30R provided at the input device 100. More specifically, it may be configured to employ a method of sliding a finger in a one specific direction or in both directions in a reciprocating manner in a state of the finger being in touch with the touch sensors 30U or 30D provided at the vertical sides or 30L or 30R at the horizontal sides. Furthermore, regarding a sliding manner of a finger in such a case, it may be configured to set in detail the speed of the movement of the finger, the number of times of temporarily stopping the sliding operation of the finger, etc. These unlocking methods may be applied solely or combined arbitrarily, or may be applied with an unlocking condition of ending the unlocking method within a certain period of time by setting a specific unlocking time. Furthermore, as described above in the embodiment, for the configuration in which the touch screen is provided at the display unit 20 or the tactile switch 35 is provided at the lateral side of the outer circumference of the housing 10, these operations may be multiply combined to the unlocking methods. In this way, by making the unlocking condition of the lock function complex, the security performance can be improved.

Although some embodiments of the present invention are described above, the present invention is not limited thereto and includes the invention recited in the claims as well as the equivalent scope thereof.

What is claimed is:

1. An input device comprising:
a display unit having a display area;
a first sensor unit that is provided to be layered on the display area and detects first touch operation;
at least one second sensor unit that is provided at an area that does not overlap the display area and detects second touch operation; and
a control unit that acquires each detection result from the first sensor unit and the at least one second sensor unit and executes control processing corresponding to the detection result acquired.

2. The input device according to claim 1, wherein
the second sensor unit includes a 21st sensor unit and a 22nd sensor unit that face each other interposing the display area and extend in a first direction, respectively, with respect to the display area.

3. The input device according to claim 2, wherein,
the control unit executes rotating an image displayed on the display area when the second touch operation is a combination in which a moving direction of a position detected at the 21st sensor unit is the first direction and a position detected at the 22nd sensor unit moves in a direction opposite to the first direction.

4. The input device according to claim 2, wherein,
the control unit executes scrolling an image displayed on the display area in the first direction when the second touch operation is a combination in which a position detected at the 21st sensor unit and a position detected at the 22nd sensor unit move in the first direction.

5. The input device according to claim 2, wherein
the second sensor unit further includes a 23rd sensor unit and a 24th sensor unit that face each other interposing the display area and extend to a second direction, respectively, that is perpendicular to the first direction with respect to the display area.

6. The input device according to claim 5, wherein,
the control unit executes rotating an image displayed on the display area when the second touch operation is a combination in which a moving direction of a position detected at the 23rd sensor unit and a moving direction of a position detected at the 24th sensor unit are opposite.

7. The input device according to claim 5, wherein,
the control unit executes scrolling an image displayed on the display area in the second direction when the second touch operation is a combination in which a position detected at the 23rd sensor unit and a position detected at the 24th sensor unit move in the second direction.

8. The input device according to claim 1, wherein,
the control unit executes displaying an image displayed on the display area to be enlarged in a case in which a movement direction detected by the second touch operation is a predetermined direction in a state detected by the first touch operation.

9. An input method executed by an input device including:
a display unit having a display area;
a first sensor unit that is provided to be layered on the display area and detects first touch operation; and
at least one second sensor unit that, is provided at an area that does not overlap the display area and detects second touch operation;
the input method comprising the steps of:
acquiring each detection result from the first sensor unit and the at least one second sensor unit; and
executing control processing corresponding to the detection result acquired.

10. A non-transitory storage medium encoded with a computer-readable program that enables a computer that controls an input device including:
a display unit having a display area;
a first sensor unit that is provided to be layered on the display area and detects first touch operation; and
at least one second sensor unit that is provided at an area that does not overlap the display area and detects second touch operation,
to execute functions as:
a control unit that acquires each detection result from the first sensor unit and the at least one second sensor unit and executes control processing corresponding to the detection result acquired.
